(19) United States
(12) Patent Application Publication
(10) Pub. No.: US 2024/0288393 A1
(43) Pub. Date: Aug. 29, 2024

(54) METHOD FOR OPERATING A SEMICONDUCTOR GAS SENSOR, AND SEMICONDUCTOR GAS SENSOR

(71) Applicant: Robert Bosch GmbH, Stuttgart (DE)

(72) Inventors: Christoph Schelling, Stuttgart (DE); Richard Fix, Weil Im Schoenbuch (DE); Susanne Eicker, Reutlingen (DE)

(21) Appl. No.: 18/583,436

(22) Filed: Feb. 21, 2024

(30) Foreign Application Priority Data
Feb. 27, 2023 (DE) 10 2023 201 750.4

(51) Int. Cl. G01N 27/12; G01N 27/14

(52) U.S. Cl. CPC G01N 27/124; G01N 27/14; G01N 27/125

(57) ABSTRACT

A method for operating a semiconductor gas sensor. The semiconductor gas sensor has a sensor element with a sensor material having a semiconductor, a plurality of measuring electrodes electrically connected to the sensor material for exciting and reading the sensor material, and a control and evaluation device for generating excitation signals and evaluating read measurement signals. A surface of the sensor material is exposed to a gaseous medium. In the method, a first excitation signal and a second excitation signal are applied to the sensor material. The excitation signals have different excitation frequencies. A first measurement signal is read based on the first excitation signal, and a second measurement signal is read based on the second excitation signal. A sensor signal is ascertained based on the excitation signals and the measurement signals.

### CROSS REFERENCE

The present application claims the benefit under 35 U.S.C. § 119 of German Patent Application No. DE 10 2023 201 750.4 filed on Feb. 27, 2023, which is expressly incorporated herein by reference in its entirety.

### FIELD

The present invention relates to a method for operating a semiconductor gas sensor and to a semiconductor gas sensor.

### BACKGROUND INFORMATION

Semiconductor gas sensors are described in the related art. Semiconductor gas sensors have a sensor material which changes its electrical conductivity under the influence of a gas. Such sensor materials are in particular metal oxides, such as tin (IV) oxide (SnO₂). In this case, the semiconductor gas sensors can also be referred to as metal-oxide semiconductor gas sensors (MOX sensors). In the case of MOX sensors which are based on tin dioxide, oxygen defects in the crystal lattice bring about an n-doping. A change in oxygen coverage of a surface of the tin dioxide consequently brings about a change in the conductivity of the tin dioxide in the region of the surface, which can be measured macroscopically in a change of a resistance or an impedance. In general, it is, for example, true that reducing gases in an n-semiconductor bring about an increase in the conductivity, whereas oxidizing gases reduce the conductivity.

The magnitude of the change in conductivity inter alia depends on the gas concentration.

Semiconductor gas sensors are widely used due to their ability to detect numerous gases via the selection of the base semiconductor material and the doping thereof. A so-called drift of semiconductor gas sensors can however limit their reliability and their usability. Said drift limits the achievable accuracy and a minimum detection limit. This poses a problem in particular for safety-critical applications of semiconductor gas sensors. Recalibrations during operation are complicated to carry out and are not possible in every case.

A drift of a semiconductor gas sensor is to be understood as a variation of a measurement signal over time, even if the conditions to which the sensor material is exposed are not changed. A drift can, for example, occur due to aging processes at the surface of the sensor material. For example, a reorganization of the sensor material takes place in the region of the surface. In addition, adsorbates may be irreversibly bonded to the surface. Furthermore, the measurement signal is, for example, influenced by changes in the temperature of the sensor material, changes in a moisture of an environment, and pressure changes.

### SUMMARY

An object of the present invention is to specify an improved method for operating a semiconductor gas sensor and to provide an improved semiconductor gas sensor. This object may be achieved by a method for operating a semiconductor gas sensor and by a semiconductor gas sensor having features of the present invention. Advantageous developments of the present invention are disclosed herein.

In a method for operating a semiconductor gas sensor, the semiconductor gas sensor has a sensor element with a sensor material having a semiconductor, a plurality of measuring electrodes electrically connected to the sensor material for exciting and reading the sensor material, and a control and evaluation device for generating excitation signals and evaluating read measurement signals. A surface of the sensor material is exposed to a gaseous medium. According to an example embodiment of the present invention, the method has the following method steps. A first excitation signal and a second excitation signal are applied to the sensor material. The excitation signals have different excitation frequencies. A first measurement signal is read on the basis of the first excitation signal, and a second measurement signal is read on the basis of the second excitation signal. A sensor signal is ascertained on the basis of the excitation signals and the measurement signals.

The excitation signals and the measurement signals are electrical signals. Voltage signals can in particular be used as excitation signals. The second excitation signal can also be referred to as a reference signal. In particular, current intensity signals can be read as measurement signals. The sensor signal can thus, for example, be ascertained on the basis of resistances of the sensor material. For example, the sensor signal can be represented by correlated resistances, for example by a difference or a ratio of two resistances. In the context of this description, either an ohmic resistance or a complex resistance, i.e., an impedance, is referred to as a resistance.

According to an example embodiment of the present invention, the sensor signal can thus, for example, be based on a difference or a ratio of a first resistance and a second resistance. The first resistance is ascertained on the basis of the first excitation signal and the first measurement signal. The second resistance is ascertained on the basis of the second excitation signal and the second measurement signal. In this case, it may be necessary to ascertain or take into account a capacitance of the semiconductor gas sensor and/or phase shifts between electrical voltages and electrical currents. In addition, it may be necessary to ascertain or take into account inductances. In this case, it is important which measurement method is used to read the measurement signals. For example, bridge circuits or resonant circuits can be used to determine resistances and impedances.

Advantageously, the method of the present invention makes it possible to provide a sensor signal in which a drift of the semiconductor gas sensor is already taken into account or compensated. The drift can in particular be compensated by selecting the excitation frequencies in such a way that a quantitatively gas-responsive behavior of the sensor material is present at a low excitation frequency, whereas a drift-responsive behavior of the sensor material is brought about at a higher excitation frequency. A robust, drift-corrected sensor signal can advantageously be obtained by forming the difference or ratio of the two read measurement signals. Furthermore, an increase in selectivity to particular gases can also be achieved by skillfully selecting the frequency. In addition to the selectivity, a sensitivity to different gases can optionally also be increased.

However, according to an example embodiment of the present invention, it is also possible for a DC voltage signal (offset) to be used as the first excitation signal, wherein a first excitation frequency of the first excitation signal assumes the value zero, whereas the second excitation signal has a second excitation frequency not equal to zero and is thus dynamic (e.g., periodically pulsating/alternating). This advantageously makes it possible to measure the resistivity of the sensor material and the capacitance of the semiconductor gas sensor independently of one another. A higher gas selectivity of the semiconductor gas sensor can thereby advantageously be achieved.

In one embodiment of the present invention, the application of the excitation signals and the reading of the measurement signals take place simultaneously in each case. In this case, a superposition of the excitation signals to form a sum excitation signal takes place and the sum excitation signal is applied to the sensor material. A sum measurement signal consisting of superposed measurement signals is read and split into the measurement signals. Splitting can also be referred to as filtering. This advantageously makes it possible to detect measurement values within a very short time since the measurement on the basis of the first excitation signal and the reference measurement on the basis of the second excitation signal take place in parallel and not in series.

An integrator circuit is, for example, suitable for extracting a DC measurement signal from the sum measurement signal consisting of superposed measurement signals. A lock-in circuit is, for example, suitable for the extraction of AC components. However, the measurement signals can also be filtered from the sum measurement signal by splitting the sum measurement signal into frequency components of the excitation signals. In this way, within a shortest possible time, measurement signals can be read and two resistance values can be determined and, when ascertaining the sensor signal, can be correlated with one another.

In one embodiment of the present invention, sinusoidal excitation signals are applied to the sensor material. The sinusoidal excitation has the advantage that no undesired additional frequency components occur. In addition to a purely sinusoidal excitation, other excitation forms with additional frequency components are also possible, for example a square wave excitation or a sawtooth excitation.

In one embodiment of the present invention, at least one third excitation signal is applied to the sensor material, and at least one third measurement signal is read on the basis of the third excitation signal. All excitation signals have different excitation frequencies. Advantageously, by applying more than two excitation signals and accordingly by reading more than two measurement signals, a sensor signal based on the in each case more than two excitation signals and more than two measurement signals can be provided, which sensor signal is particularly reliable. For example, the at least one third excitation signal can have a third excitation frequency which brings about a particularly drift-responsive behavior of the semiconductor gas sensor. For example, first, two resistance values for drift-responsive behavior can be ascertained, which are averaged first before the averaged value is correlated with a resistance value for gas-responsive behavior when ascertaining the sensor signal.

In one embodiment of the present invention, the sensor material is heated while the excitation signals are applied and the measurement signals are read. A further problem of conventional semiconductor gas sensors is with regard to their power consumption. A maximum sensitivity of the sensor material and desirable dynamics of the measurement signals require heating of the sensor material during the duration of the measurement operation. Both the response time and the sensitivity of the system can thus be improved. In the method presented here according to the present invention, drift-corrected sensor signals can be provided within a very short time so that the power consumption can advantageously be minimized by switching off a heater in good time.

In one embodiment of the present invention, the excitation signals are applied after the sensor material has reached a temperature intended for the measurement. This advantageously ensures defined measurement conditions and good reproducibility of the measurement results.

In one embodiment of the present invention, measurement signals for a plurality of different temperatures are read. In this way, a higher selectivity and sensitivity of the semiconductor gas sensor can be achieved.

In one embodiment of the present invention, the sensor material is heated according to a temperature-time ramp while the excitation signals are applied and the measurement signals are read. In this way, the reactive gas dynamics during the temperature ramp are also detected. A higher selectivity of the semiconductor gas sensor can thereby be achieved.

A semiconductor gas sensor has a sensor element with a sensor material having a semiconductor, measuring electrodes electrically connected to the sensor material for exciting and reading the sensor material, and a control and evaluation device connected to the measuring electrodes for generating excitation signals and evaluating read measurement signals. A surface of the sensor material is exposed to a gaseous medium. The control and evaluation device is designed to carry out a method according to any of the embodiments.

According to an example embodiment of the present invention, the control and evaluation device is thus designed to generate excitation signals of different excitation frequencies, optionally to generate a sum excitation signal from a plurality of excitation signals by superposition, to apply the excitation signals or the sum excitation signal to the sensor material, to read the measurement signals, and to ascertain the sensor signal on the basis of the excitation signals and the measurement signals. The control and evaluation device is also designed to, if necessary, filter the measurement signals from a sum measurement signal or to split the sum measurement signal into the individual measurement signals. For this purpose, the control and evaluation device can, for example, have the integrator circuit or the lock-in circuit. In one embodiment of the present invention, the semiconductor gas sensor has a heater for heating the sensor material.

The method for operating the semiconductor gas sensor and the semiconductor gas sensor according to the present invention are explained in more detail in the following description in connection with figures.

### BRIEF DESCRIPTION OF THE DRAWINGS

FIG. 1 shows a semiconductor gas sensor, according to an example embodiment of the present invention.

FIG. 2 shows a method for operating a semiconductor gas sensor, according to an example embodiment of the present invention.

### DETAILED DESCRIPTION OF EXAMPLE EMBODIMENTS

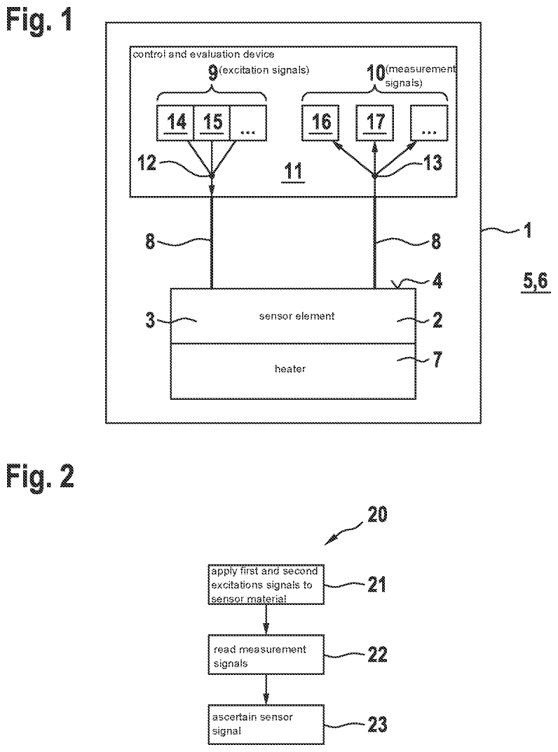

FIG. 1 schematically shows elements of a semiconductor gas sensor 1.

The semiconductor gas sensor 1 has at least one sensor element 2. The sensor element 2 has at least one sensor material 3. In the exemplary embodiment of FIG. 1, the semiconductor gas sensor 1 has precisely one sensor element 2, wherein the sensor element 2 has precisely one sensor material 3. The sensor material 3 has a semiconductor. The sensor material 3 having a semiconductor is to be understood such that the sensor material 3 can also have a doping and thus at least a certain conductivity. The sensor material 3 comprises tin dioxide by way of example. However, the sensor material 3 can also comprise a different material, for example zinc oxide, titanium dioxide, or an organic semiconductor such as MePTCDI (N, N′-dimethyl-3,4,9,10-perylenetetracarboxylic acid diimide). A surface 4 of the sensor material 3 is exposed to a gaseous medium 5 in an environment 6 of the semiconductor gas sensor 1. The semiconductor gas sensor 1 also has a heater 7 for heating the sensor material 3. However, the heater 7 can also be omitted.

The semiconductor gas sensor 1 also has a plurality of measuring electrodes 8. The measuring electrodes 8 are connected to the sensor material 3. The measuring electrodes 8 are provided to excite and read the sensor material 3. In order to generate excitation signals 9 and evaluate read measurement signals 10, the semiconductor gas sensor 1 has a control and evaluation device 11 connected to the sensor material 3 via the measuring electrodes 8.

A number of measuring electrodes 8 can vary depending on which principle is, for example, used for reading electrical voltages and/or electrical currents. Merely by way of example, FIG. 1 shows two measuring electrodes 8 for illustration purposes.

The control and evaluation device 11 is designed to generate excitation signals 9 of different excitation frequencies, optionally to generate a sum excitation signal 12 from a plurality of excitation signals 9 by superposition, to apply the excitation signals 9 or the sum excitation signal 12 to the sensor material 3, to read the measurement signals 10, and to ascertain a sensor signal on the basis of the excitation signals 9 and the measurement signals 10. The control and evaluation device 11 is also designed to, if necessary, filter the measurement signals 10 from a sum measurement signal 13 or to split the sum measurement signal 13 into the individual measurement signals 10. For this purpose, the control and evaluation device 11 can, for example, have an integrator circuit and/or at least one lock-in circuit.

The control and evaluation device 11 is designed to carry out a method 20 for operating the semiconductor gas sensor 1. FIG. 2 schematically shows method steps 21, 22, 23 of the method 20 for operating the semiconductor gas sensor 1 of FIG. 1. The method 20 allows for a reliable and drift-stable measurement of gas concentrations within a very short time and with minimal power consumption. Furthermore, a selectivity and a sensitivity of the semiconductor gas sensor 1 to different gases can be improved.

In a first method step 21, a first excitation signal 14 and a second excitation signal 15 are applied to the sensor material 3. More than two excitation signals 9 can also be applied to the sensor material 3. The plurality of excitation signals 9 can be applied to the sensor material 3 simultaneously. In this case, a superposition of the excitation signals 9 to form the sum excitation signal 12 takes place, and the sum excitation signal 12 is applied simultaneously to the sensor material 3. The excitation signals 9 have different excitation frequencies.

For example, the first excitation frequency of the first excitation signal 14 may be 10 kHz, and the second excitation frequency of the second excitation signal 15 may be 1 MHz. The first excitation frequency can also assume the value zero. In this case, the voltage applied to the sensor material 3 is thus a DC voltage. In the example, the second excitation signal 15 may have an excitation frequency of, for example, 100 kHz. However, the values and value ranges mentioned for the first and second excitation frequencies are merely exemplary and not restrictive, so that other excitation frequencies can also be selected. The excitation signals 9 can, for example, be sinusoidal, which is however not absolutely necessary.

In a second method step 22, measurement signals 10 are read on the basis of the excitation signals 9. A first and a second measurement signal 16, 17 or even more measurement signals 10 can be read depending on how many excitation signals 9, 14, 15 are applied in the first method step 21. If the excitation signals 9 are applied simultaneously, the measurement signals 10 are also read simultaneously. In this case, a sum measurement signal 13 consisting of superposed measurement signals is read and split into the measurement signals 10 or its measurement signal components 16, 17, . . . .

In a third method step 23, a sensor signal is ascertained on the basis of the excitation signals 9 and the measurement signals 10. The selection of different excitation frequencies makes it possible that, on the one hand, gas-responsive measurement signals 10 and, on the other hand, drift-responsive measurement signals 10 can be obtained, which can be correlated with one another when ascertaining the sensor signal, whereby the sensor signal can be drift-corrected.

The sensor material 3 can be heated while the excitation signals 9 are applied and the measurement signals 10 are read. In this case, the application of the excitation signals 9 cannot take place until after the sensor material 3 has reached a temperature intended for the measurement. Measurement signals 10 for a plurality of different temperatures can thus be read. In a variant of the method, the sensor material 3 can be heated according to a temperature-time ramp while the excitation signals 9 are applied and the measurement signals 10 are read.

What is claimed is:

1. A method for operating a semiconductor gas sensor, wherein the semiconductor gas sensor has a sensor element with a sensor material having a semiconductor, a plurality of measuring electrodes electrically connected to the sensor material for exciting and reading the sensor material, and a control and evaluation device configured to generate excitation signals and evaluate read measurement signals, and wherein a surface of the sensor material is exposed to a gaseous medium, the method comprising the following steps:
applying a first excitation signal and a second excitation signal to the sensor material, wherein the first and the second excitation signals have different excitation frequencies relative to one another;
reading a first measurement signal based on the first excitation signal, and a second measurement signal based on the second excitation signal; and
ascertaining a sensor signal based on the first and second excitation signals and the first and second measurement signals.

2. The method according to claim 1, wherein wherein the application of the first and second excitation signals and the reading of the first and second measurement signals take place simultaneously in each case, and wherein a superposition of the first and second excitation signals to form a sum excitation signal takes place and the sum excitation signal is applied to the sensor material, and wherein a sum measurement signal including superposed first and second measurement signals is read and split into the first and second measurement signals.

3. The method according to claim 1, wherein sinusoidal excitation signals are applied to the sensor material.

4. The method according to claim 1, wherein at least one third excitation signal is applied to the sensor material, and wherein at least one third measurement signal is read based on the third excitation signal.

5. The method according to claim 1, wherein the sensor material is heated while the first and second excitation signals are applied and the first and second measurement signals are read.

6. The method according to claim 5, wherein the first and second excitation signals are applied after the sensor material has reached a temperature intended for the measurement.

7. The method according to claim 6, wherein measurement signals for a plurality of different temperatures are read.

8. The method according to claim 5, wherein the sensor material is heated according to a temperature-time ramp while the first and second excitation signals re applied and the first and second measurement signals are read.

9. A semiconductor gas sensor, comprising:
a sensor element with a sensor material having a semiconductor;
a plurality of measuring electrodes electrically connected to the sensor material configured for exciting and reading the sensor material, and
a control and evaluation device connected to the measuring electrodes, configured to generate excitation signals and evaluate read measurement signal;
wherein a surface of the sensor material is exposed to a gaseous medium, and
wherein the control and evaluation device is configured to:
apply a first excitation signal and a second excitation signal to the sensor material, wherein the first and the second excitation signals have different excitation frequencies relative to one another;
read a first measurement signal based on the first excitation signal, and a second measurement signal based on the second excitation signal; and
ascertain a sensor signal based on the first and second excitation signals and the first and second measurement signals.

10. The semiconductor gas sensor according to claim 9, further comprising a heater configured to heat the sensor material.
